(19) United States
(12) Patent Application Publication
(10) Pub. No.: US 2007/0288875 A1
(43) Pub. Date: Dec. 13, 2007

(54) Skew clock tree

(75) Inventors: Paul Eakins, Cambridge (GB); Paul Cunningham, Mountain View, CA (US); Stephen Wilcox, Cambridge (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Azuro (UK) Limited, Cambridge (GB)

(21) Appl. No.: 11/449,974

(22) Filed: Jun. 8, 2006

(51) Int. Cl. G06F 17/50

(52) U.S. Cl. 716/6

(57) ABSTRACT

A method, graphical user interface, and computer program product on a computer readable medium are disclosed for presenting a user with a display of a skew clock tree for a digital circuit design. In the preferred embodiment, a computer system receives timing analysis data for a digital circuit. The computer system determines a propagation time delay between a first clock root and each of a plurality of clock sinks of the digital circuit associated with the first clock root based on the timing analysis data. The computer system then displays the first clock root and each clock sink associated with the first clock root of the skew clock tree along an axis representing time delay. In the displayed skew clock tree, each clock sink is positioned along the axis relative to the first clock root based on each clock sink's determined propagation time delay.

### BACKGROUND OF THE INVENTION

The present invention relates to electronic design automation, and more particularly to visualization of skew clock trees of digital circuits.

High-performance synchronous integrated circuits have traditionally been characterized by the clock frequency at which the integrate circuits operate. Additionally, a large, pipelined digital circuit may easily contain hundreds of clocked elements. Circuit designers typically ensure proper timing of digital circuits by carefully planning and implementing distribution of clocks and clock signals throughout the digital circuits. At numerous steps in the design process, a circuit designer gauges the ability of the circuit to operate at specified speeds by measuring clock delay in the digital circuit.

One technique to assist in the planning and implementation of a digital circuit is to develop a clock tree for the digital circuit. The clock tree describes the interconnect geometry that connects a clock to all the cells or components on the digital circuit that use the clock. These cells can consist of clock buffers, latches, flip-flops, and other logic gates and elements that need to be synchronized with the clock.

For the circuit designer, some of the major concerns in developing the clock tree are minimizing clock skew, optimizing clock buffers to meet the clock skew specifications, and minimizing clock tree power dissipation. Clock skew occurs when a clock signal arrives at different cells or components (e.g., two flip-flop clock inputs) on the digital circuit at different times. Clock skew can result from differences in interconnect capacitance due to differing segment lengths, the placement of clock buffers, and the number, placement, and types of clocked elements being driven by the clock.

Poor clock distribution can therefore cause reduced performance or malfunction in the digital circuit. Moreover, minimizing clock skew can reduce hold-time violations, for example, which can cause flip-flops to operate in metastable states and provoke random failures in the digital circuit. Clock skew minimization is also important because clock skew reduces performance in the digital circuit by reducing the operating frequency of the digital circuit.

FIG. 1 is an illustration of a clock tree 100 for a digital circuit in the prior art. The clock tree 100 includes a clock root 105 (e.g., a pad for receiving the clock signal) linked to one or more cells or components of the digital circuit. In this example, the clock tree 100 includes a clock gate 120 and clock buffers 110, 115, 125, 130, 135, 140, and 145. Black dots 150 represent clock sinks or inputs to a clocked component, such as a flip-flop. As stated previously, there can be many types of cells or components in the clock tree 100, including buffers, clock gates, multiplexers, dividers, phase-locked loops (PLLs), and inverters.

In this example, the clock tree 100 corresponds to the physical layout of the digital circuit. One problem with mirroring the physical layout of the digital circuit is that the clock tree 100 conveys minimal information about clock skew or latency to the circuit designer. For example, the circuit designer cannot determine whether the clock tree 100 is balanced. In other words, the circuit designer cannot determine from the clock tree 100 whether the clock signal arrives at each of the clock sinks at approximately the same time.

FIG. 2 is an illustration of a topological view of a clock tree 200 in the prior art. In this example, the clock tree 200 depicts the clock root 105 at the top of the view. Each component in the clock tree is placed at a particular level depending on its position in the circuit relative to the clock root. In this example, the clock buffer directly connected to the clock root appears at level 1 with the clock root 105 at level 0; two clock buffers, one clock gate and a clock sink directly connected to the clock buffer in level 1 appear at level 2; and so on.

FIG. 3 is an illustration of a modified topological view of a clock tree 300 in the prior art. In this example, the clock tree 300 depicts the clock root again at the top of the view. As in FIG. 2, each component in the clock tree is placed at a particular level depending on its relative position in the circuit relative to the clock root. However, the clock tree 300 attempts to keep the aspect ratio of the tree constant in progressing down clock tree. The levels get closer as the components are farther from the clock root 105 down the clock tree 300.

Although the clock trees 200 and 300 indicate to the circuit designer some relationship between the clock root 105 and the components, the clock trees 200 and 300 do not convey or convey minimal information about clock skew or latency. Additionally, the clock trees 200 and 300 do not indicate to the circuit designer any delay between components. Thus, there is a need for techniques that allow visualization and representation of clock trees of digital circuits that better aid in the design process.

### BRIEF SUMMARY OF THE INVENTION

The present invention relates to electronic design automation, and more particularly to visualization of skew clock trees of digital circuits.

A computer program product is disclosed having a computer-readable medium for storing instructions to present a user with a display of a skew clock tree. The instructions, when executed by a computer system, instruct the computer system to receive timing analysis data for a digital circuit. The computer system then determines a propagation time delay between a first clock root and each of a plurality of clock sinks of the digital circuit associated with the first clock root based on the timing analysis data. The computer system displays the first clock root and each clock sinks associated with the first clock root along an axis representing time delay. In the displayed skew clock tree, each clock sink is positioned along the axis of the skew clock tree relative to the first clock root based on each clock sink's determined propagation time delay.

In embodiments of the present invention, the computer system displays the first clock root and each clock sink associated with the first clock root of the skew clock tree to enable the user to determine whether the skew clock tree is balanced. The skew clock tree may include a plurality of circuit components interconnected between the first clock root and one or more of the plurality of clock sinks associated with the first clock root. The circuit components may include one or more of buffers, inverters, clock gates, clock multiplexers, and clock dividers.

The computer system may determine a propagation time delay between the first clock root and each of the plurality of circuit components based on the timing analysis data. The computer system displays each circuit component positioned along the axis of the skew clock tree relative to the first clock root based on each circuit components determined propagation time delay. The displayed skew clock tree may show interconnections between the first clock root, the circuit components, and the clock sinks associated with the first clock root. The computer system also may map colors to the circuit components in accordance with the type of each circuit component.

In some embodiments, the computer system maps colors to the plurality of clock sinks associated with the first clock sink in accordance with their determined propagation time delay. The computer system may display a path of reconvergence visually represented by a dashed line in the displayed skew clock tree. The computer system may also determining a propagation time delay between a second clock root of the digital circuit and each of a plurality of clock sinks associated with the second clock root based on the timing analysis data. The computer system then displays the second clock root and each of the plurality of clock sinks associated with the second clock root along the axis representing time delay. In the displayed skew clock tree, each clock sink is positioned along the axis relative to the second clock root based on each clock sink's determined propagation time delay.

The displayed skew clock tree may include a first displayed clock tree including the first clock root and each clock sink associated with the first clock root and a second displayed clock tree including the second clock root and each clock sink associated with the second clock root. The computer system may display the first clock root and each clock sink associated with the first clock root and displaying the second clock root and each clock sink associated with the second clock enables the user to determine whether the first displayed clock tree is balanced with respect to the second displayed clock tree.

The displayed skew clock tree may include a parent clock tree including the first clock root and each clock sink associated with the first clock tree and a child clock tree including the second clock root and each clock sink associated with the second clock root. The computer system then may display a dashed lined to visually represent a relationship between the parent clock tree and the child clock tree.

A method of presenting a user with a display of a skew clock tree is disclosed. The method includes receiving timing analysis data for a digital circuit, determining a propagation time delay between a first clock root and each of a plurality of clock sinks of the digital circuit associated with the first clock root based on the timing analysis data, and displaying the first clock root and each clock sink associated with the first clock root along an axis representing time delay, wherein each clock sink is positioned along the axis of the skew clock tree relative to the first clock root based on each clock sink's determined propagation time delay.

A graphical user interface is disclosed for a computer system display. The graphical user interface includes a first portion and a second portion. The first portion displays an axis representing time delay with units of time displayed on the axis. The second portion displays a first clock root and a plurality of clock sinks associated with the first clock root of a clock tree along the axis. Each clock sink associated with the first clock root has a predetermined propagation time delay from the first clock root. The second portion displays each clock sink associated with the first clock root positioned along the axis relative to the first clock root based on each clock sink's propagation time delay.

A further understanding of the nature and the advantages of the invention disclosed herein may be realized by reference to the remaining portions of the specification and the attached drawings.

### BRIEF DESCRIPTION OF THE DRAWINGS

FIG. 1 is an illustration of a clock tree for a digital circuit in the prior art.

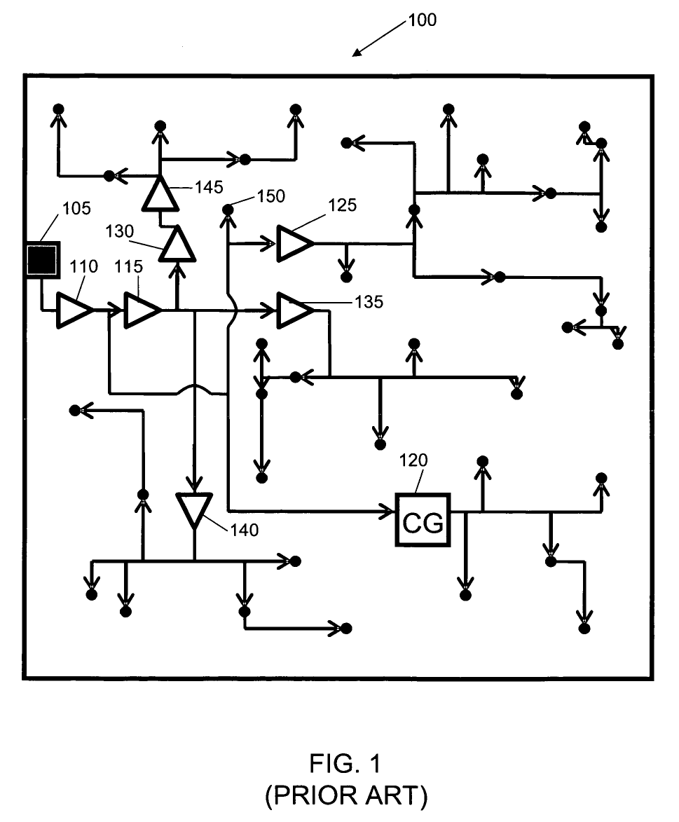

FIG. 2 is an illustration of a topological view of a clock tree in the prior art.

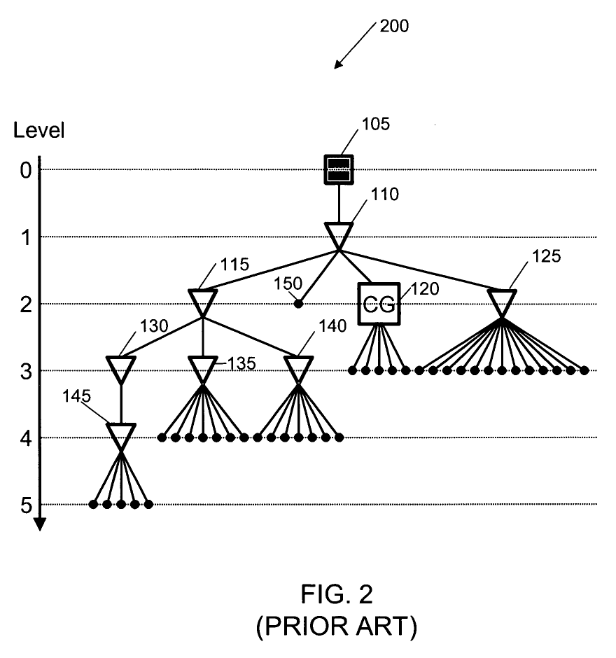

FIG. 3 is an illustration of a modified topological view of a clock tree in the prior art.

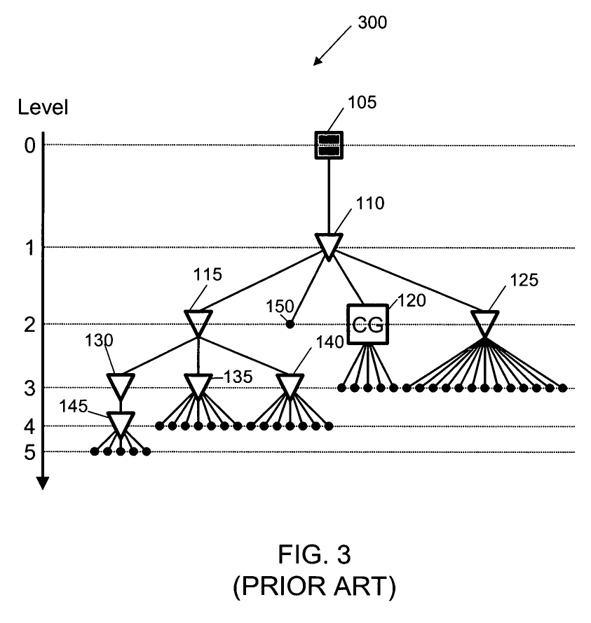

FIG. 4 is a block diagram of a computer system for generating a skew clock tree in an exemplary implementation of the invention.

FIG. 5 is a flowchart for skew clock tree visualization in an exemplary implementation of the invention.

FIG. 6 depicts an exemplary skew clock tree in an exemplary implementation of the invention.

FIG. 7 depicts skew groups of an exemplary skew clock tree visualization in an exemplary implementation of the invention.

FIG. 8 depicts an exemplary skew clock tree visualization including two clock trees in an exemplary implementation of the invention.

FIG. 9 depicts an exemplary skew clock tree visualization including two clock trees, wherein one clock tree has a non-zero source latency in an exemplary implementation of the invention.

FIG. 10 depicts an exemplary skew clock tree visualization including two clock trees, wherein the two clock trees have substantially the same insertion delay and are substantially balanced in an exemplary implementation of the invention.

FIG. 11 depicts an exemplary skew clock tree visualization including two clock trees, wherein a first clock tree is a parent clock tree and a second clock tree is a child clock tree in an exemplary implementation of the invention.

FIG. 12 depicts an exemplary skew clock tree visualization that includes a reconvergence path in an exemplary implementation of the invention.

### DETAILED DESCRIPTION OF THE INVENTION

According to the present invention, techniques are provided which assist in the design process of digital circuits through the visualization of skew clock trees. In some embodiments, a user (e.g., a circuit designer) of a computer system selects timing analysis data (from sources such as a placed gate netlist, DEF/PDEF, SDC, lib, or LEF file) for a digital circuit. The computer system acts upon the timing analysis data to determine one or more clock roots of the digital circuit. The computer system identifies the various components connected between the one or more clock roots and one or more clock sinks associated with each of the one or more clock roots. The computer system then determines an insertion delay or propagation time delay between the one or more clock roots and the one or more clock sinks associated with each of the one or more clock roots of the digital circuit. The computer system then generates corresponding graphical representations of skew clock trees of the one or more clock roots of the digital circuit for display to the circuit designer.

The computer system can determine the insertion delay or propagation time delay between a clock root and a circuit component or clock node. The computer system then determines the propagation delay from the circuit component to a clock sink. If there are a plurality of circuit components or clock nodes between a clock root and a clock sink, the computer system determines the corresponding propagation time delays (such as from a clock root to a component, and from the component to a clock sink) and generates graphical representations in the skew clock tree for display to the circuit designer.

Advantageously, the circuit designer can quickly determine from the skew clock tree visualization generated by the computer system a key figure-of-merit about the clock tree of the digital circuit. Namely, whether one or more clock trees in the digital circuit are balanced or not. A clock tree is balanced if the insertion delay or propagation time delay from a clock root, through various components or nodes, and to each clock sink is the same to within some tolerance or threshold.

The circuit designer can visually determine the insertion delay or propagation time delay for a clock sink, a circuit component, or group of clock sinks or circuit components. The circuit designer can also readily identify skew groups (e.g., groups of cells or components balanced with respect to one another, but not to the rest of the cells or components), and cells or components of the digital circuits that are given special clock signal treatment. Additionally, the designer can determine whether any circuit components along the clock tree are overloaded because there would be a large time delay between two components along a branch of the clock tree. Such large time delays can easily be identified since they would appear as large vertical gaps in the clock tree representation.

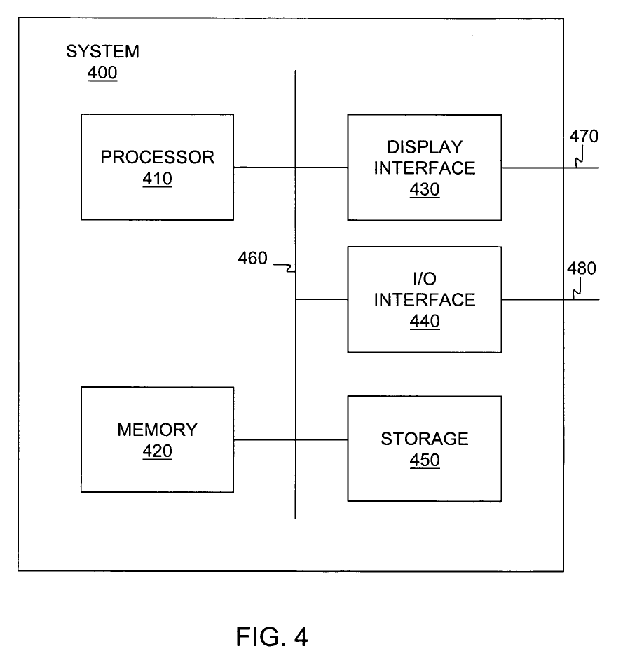

FIG. 4 is a block diagram of a computer system 400 for generating a skew clock tree in an exemplary implementation of the invention. The computer system 400 includes a processor 410, a memory 420, a display interface 430, an input/output (I/O) interface 440, and a storage 450. A bus 460 exchanges data between the processor 410, the memory 420, the display interface 430, the I/O interface 440, and the storage 450. The display interface 430 is linked via line 470 to, for example, a display device (e.g., a monitor). The I/O interface 440 receives input via line 480, for example, from a keyboard and/or a mouse, and may transmit data to a printer.

The computer system 400 may be programmed with computer programs stored on the storage 450 to perform various tasks. These tasks might involve accepting user input, and/or displaying images or text via the display interface 430. The processor 410 interprets input signals provided on the bus 460. The processor 410 uses the memory 420 (e.g., RAM or random access memory) for storage of program variables as needed. The bus 460 also provides a path for the processor 410 to send output signals to a monitor via the display interface 410. If used, the computer system 400 can communicate over a network (not shown) with a communications interface (e.g., a network interface card or modem).

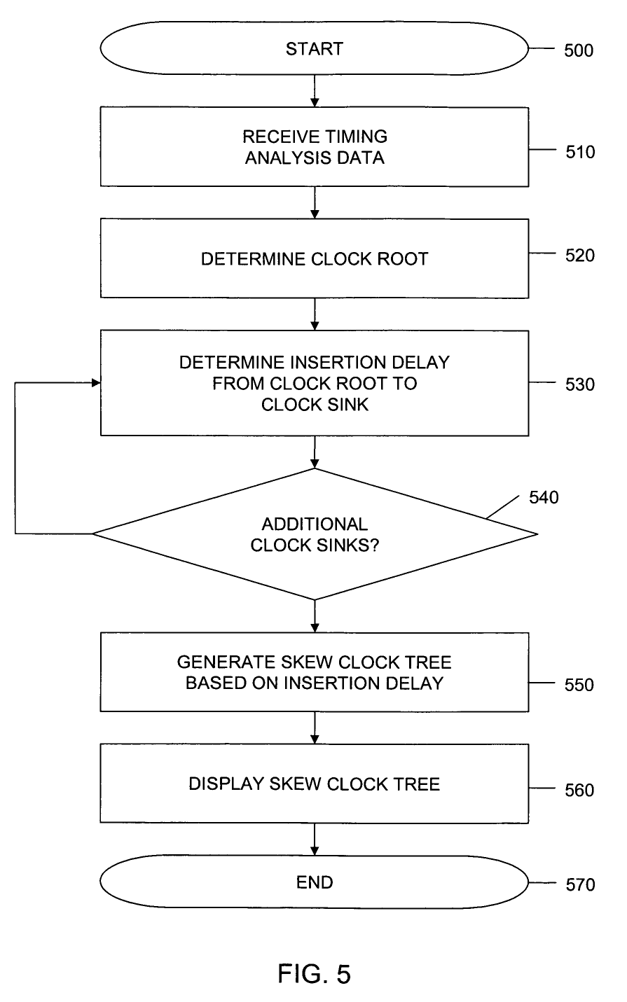

FIG. 5 is a flowchart for skew clock tree visualization in an exemplary implementation of the invention. The flow chart in FIG. 5 starts at step 500. In step 510, the processor 410 receives timing analysis data for a digital circuit.

In general, the timing analysis data is produced from a static timing analyzer using a combination of information sources. In one example, the timing analysis data is determined for one or more components of a digital circuit from a vendor component library that describes the one or more components. A vendor component library typically includes Synopsys' Non-Linear Delay Model (NLDM), Cadence's Effective Current Source Model (ECSM), Synopsys' Composite Current Source (CCS) model, and the like. In another example, the timing analysis data includes a static delay of a clock signal between different components of the digital circuit.

In one example, the timing analysis data is determined from placed gates information. The placed gates information may include the positions of cells in the digital circuit design and the interconnections between the cells. The timing analysis data may optionally be determined from routing information. Additionally, the computer system 400 may generate example routes based on the timing analysis data to determine representative delay and capacitance information of the digital circuit.

In this example, the timing analysis data is determined from a DEF file for cell placement and routing information and a Verilog netlist for the interconnections. The DEF file lists cells in the digital circuit design together with X and Y coordinates of the cells. If routing information is supplied, the DEF file includes a list of polygons that represent rectangles of metal in the digital circuit design. The Verilog netlist includes a series of hierarchical module declarations, and declares wires, cells, and the interconnection between the wires and cells in the digital circuit design. The timing analysis data may also be determined from information in a PDEF file for cell placement or in a DEF file for cell interconnections.

In step 520, the processor 410 selects a clock root of the digital circuit. In step 530, the processor 410 selects a clock sink, or circuit component or clock node. As discussed above, there may be a number of circuit components or clock nodes between the clock root and the clock sink. In step 540, the processor 410 determines an insertion delay or propagation time delay between the clock root and the clock sink or circuit component of the digital circuit based on the timing analysis data. The insertion delay or propagation time delay is the delay of the clock signal from the clock root through any gates, circuit components, or clock nodes (e.g., clock buffers) of the digital circuit to the clock sink. “Clock sink” as used in this disclosure refers to the clock input of a circuit components, such as a latch. In step 550, the processor 410 determines whether any other clock sinks or circuit components attached to the clock root remain from the timing analysis data.

If one or more clock sinks or circuit components remain; the processor 410 continues processing in step 530. In no clock sinks or circuit components remain, the processor 410 continues in step 560. In step 560, the processor 410 determines whether any other clock roots of the digital circuit remain from the timing analysis data. If one or more clock roots remain, the processor 410 continues processing the one or more clock roots in step 520. If no clock roots remain, the processor 410 continues in step 570.

In step 570, the processor 410 generates a skew clock tree visualization based on any clock roots and the insertion delay or propagation delay between the clock roots and the any clock sinks or circuit components associated with a clock root. Each clock sink's position along the clock tree is determined and then displayed based on its insertion delay. In step 560, the processor 410 displays the skew clock tree to the circuit designer. FIG. 5 ends in step 570.

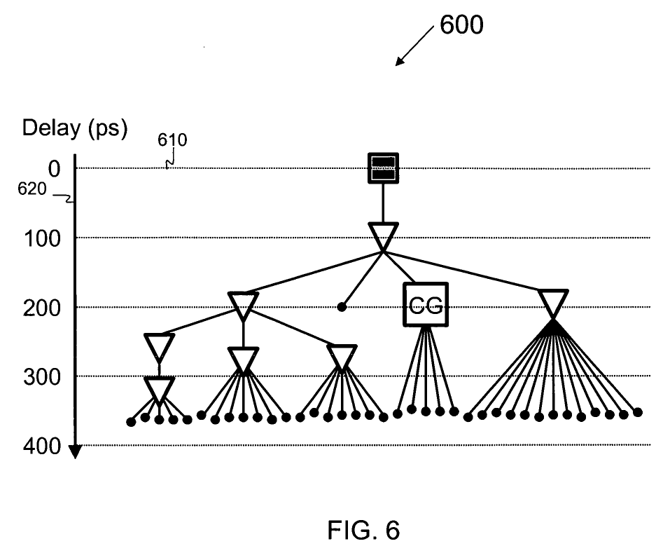

FIG. 6 depicts a delay-based exemplary skew clock tree 600 in an exemplary implementation of the invention. The delay-based skew clock tree representation 600 depicts the clock root at the origin of a y-axis 620 that represents time delay in units of picoseconds. The various components of the clock tree including the clock sinks are positioned relative to the clock root along the y-axis 620 based on their time delay from the clock root. The delays account for actual interconnect delays and gate delays through various branches of the clock tree.

Advantageously, the circuit designer can readily determine whether the clock tree 600 is balanced. In this example, most of the clock sinks have an insertion delay from the clock root of about 360 ps. There are only a few tens of picoseconds between the highest insertion delay and the lowest insertion delay, with the exception of the insertion delay of one clock sink at 200 ps. In this example, the circuit designer may have singled out this clock sink for special treatment or otherwise overlooked the clock sink during the design process.

The skew clock tree 600 also allows the circuit designer to readily determine skew groups which are sets of clock sinks that are balanced with respect to each other, but not to the rest of the components of the digital circuit. Further, the designer can easily identify larger than normal time delays since such large delays would appear as large vertical gaps in the clock tree representation. This information can be used to further improve the performance of the clock tree.

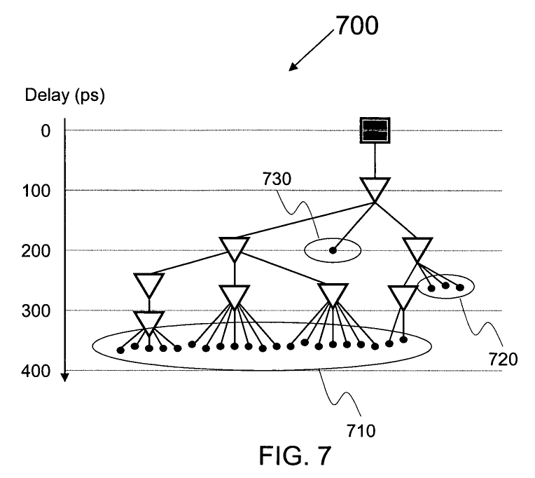

FIG. 7 depicts skew groups 710, 720, and 730 of an exemplary skew clock tree 700 in an exemplary implementation of the invention. Skew groups are groups of cells or components balanced with respect to one another, but not to the rest of the cells or components. In this example, skew group 710 includes cells or components that are balances with respect to other cells within the skew group 710. The skew group 710, in contrast, has a larger insertion delay compared to skew group 720 and skew group 730.

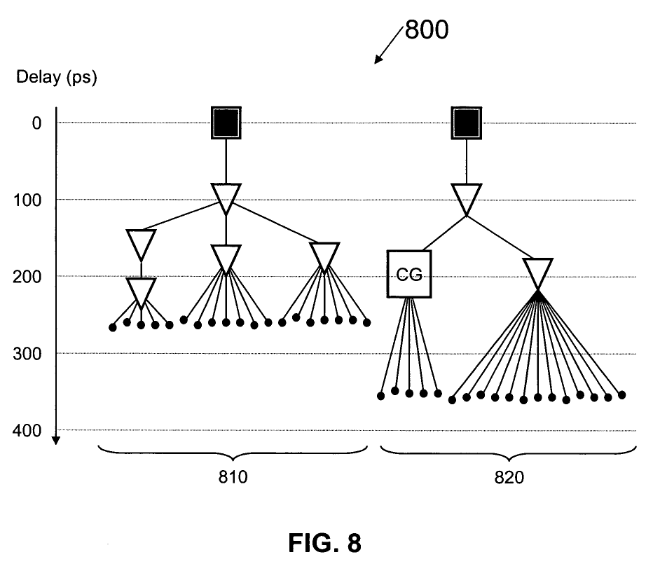

FIG. 8 depicts an exemplary skew clock tree visualization 800 including two clock trees 810 and 820 in an exemplary implementation of the invention. In this example, multiple clock trees 810 and 820 are displayed within the visualization 800. Advantageously, the designer can readily determine that although the clock trees 810 and 820 are balanced, the clock trees 810 and 820 are not balanced with respect to each other. In some examples, the visualization 800 may include clock source latencies, which are delays between clock generation and arrival at the clock roots of the clock trees 810 and 820.

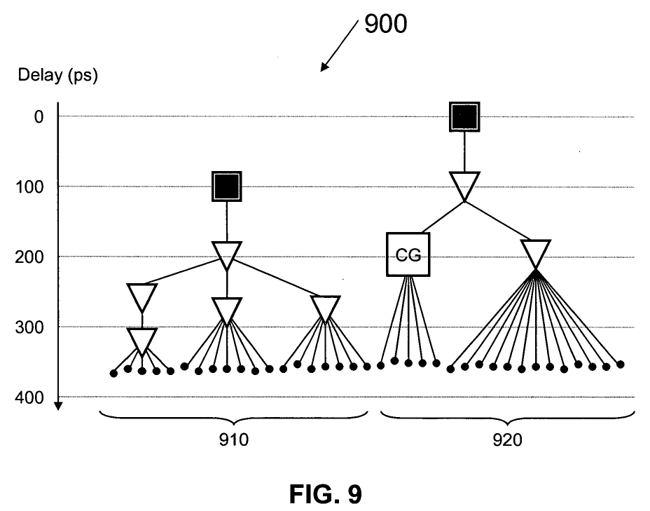

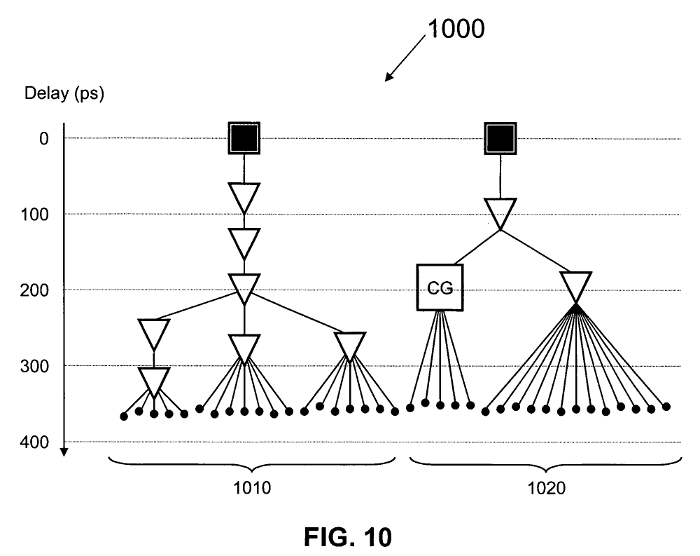

FIG. 9 depicts an exemplary skew clock tree visualization 900 including two clock trees 910 and 920, wherein the clock tree 910 has a non-zero source latency (e.g., 100 ps) in an exemplary implementation of the invention. In this example, the clock trees 910 and 920 are balanced with respect to each other due, in part, to the source latency of the clock tree 910. In another example, FIG. 10 depicts an exemplary skew clock tree visualization 1000 including two clock trees 1010 and 1020, wherein the two clock trees 1010 and 1020 have substantially the same insertion delay (e.g., no source latency) and are substantially balanced with respect to each other in an exemplary implementation of the invention.

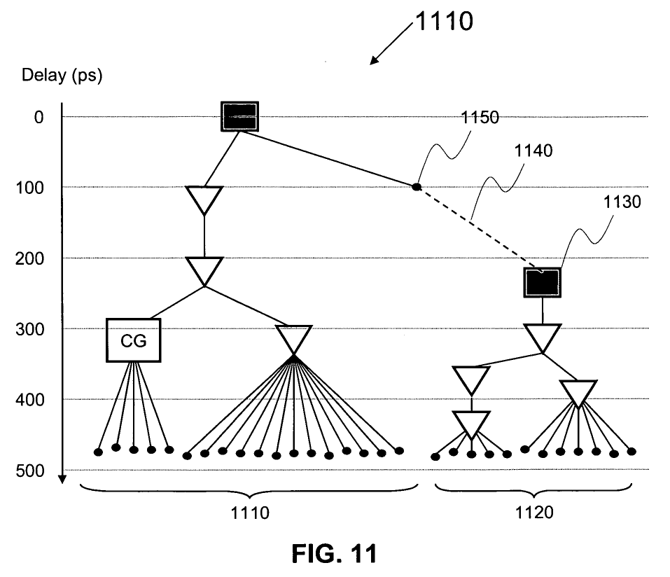

FIG. 11 depicts an exemplary skew clock tree visualization 1100 including two clock trees 1110 and 1120, wherein the first clock tree 1110 is the parent clock tree and the second clock tree 1120 is the child clock tree in an exemplary implementation of the invention. In general, a generated clock is a clock signal or clock root that is created from another clock signal or clock root in the digital circuit design, rather than being provided by the user from outside the digital circuit. For example, a generated clock tree root 1130 is the output of one or more logic gates or components (shown by dashed line 1130). The input to the one or more logic gates or components is a clock sink 1150 in the parent clock tree 1110. The generated second clock tree 1120 behaves as a sub-tree of the parent clock tree 1110, and the processor 410 represents the relationship in the skew clock tree visualization 1110. The dotted line 1140 shows the delay of the logic that generates the child clock tree.

In this example, the delay between input 1150 and the clock root 1130 can be determined, for example, by static timing analysis. The delay determines the length of the dotted line segment 1140 in the skew clock tree visualization 1100. Advantageously, the digital circuit designer can readily determine that the clock sinks of the generated child clock tree 1120 are balanced with respect to the clock sinks of the parent clock tree 1110.

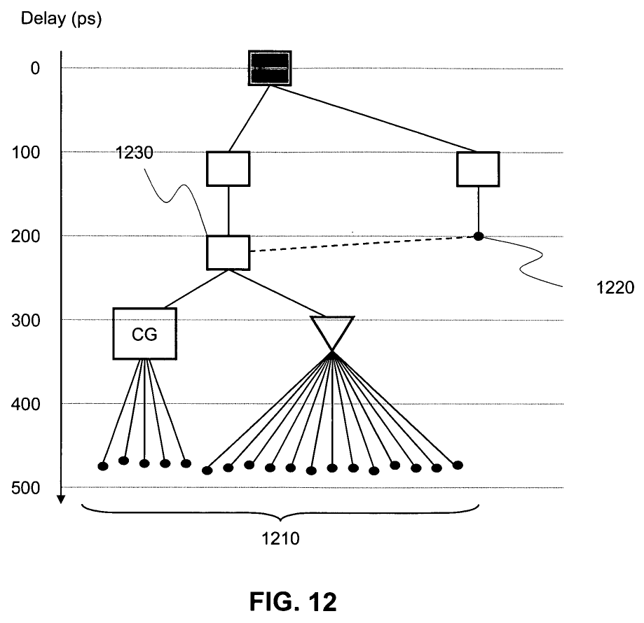

FIG. 12 depicts an exemplary skew clock tree visualization 1200 that includes a reconvergence path in an exemplary implementation of the invention. In general, clock trees can be Directed Acyclic Graphs (DAGs), where certain sub-trees can be shared by different parts of the clock tree. Clock tree reconvergence is an example of where two paths in the clock tree can come back together.

One reason for clock tree reconvergence is that the digital circuit designer may want to optionally invert the clock tree. The circuit designer multiplexes a clock signal and the inverse of the clock signal together, which creates a reconvergence point. Other examples are testing the chip after manufacture.

In this example, the dotted line segment from clock sink 1220 leads back into the main clock tree 1210 at node 1230. When the processor 410 determines a reconvergence point, the processor 410 breaks the reconvergence by declaring one path to be real (e.g. clock tree 1210), and the other to just end in a sink 1220. The sink 1220 then has a dotted line back to the main body of the clock tree 1210.

Advantageously, the digital circuit designs displayed by the processor 410 may include clock reconvergence and generated clocks, which can be displayed in a skew clock tree representation to assist the circuit designer in the design process.

Many variations of the invention are possible. For example, the actual gates (e.g., clocked mux, inverter, etc.) can be displayed in the clock tree representation rather than boxes and triangles representing the same. The various gates can be colored based on the type of gate (e.g., all inverters may be displayed with one color and all clocked multiplexers may be a displayed with a different color, and so on). The clock sinks can be colored in accordance with their insertion delay (e.g., the sinks in FIG. 6 with 350 ps insertion delay can be displayed using one color, the sinks with 355 ps insertion delay can be displayed using another color, and so on). Additionally, the slew time (i.e., the time between the 10% and 90% points of a waveform) at each circuit component and each sink in the clock tree can be displayed. Finally, the average switching activity at each circuit component and each sink in the clock tree can be displayed in the clock tree display.

The present invention can be implemented in the form of control logic in software or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method of presenting a user with a display of a skew clock tree, the method comprising:
receiving timing analysis data for a digital circuit;
determining a propagation time delay between a first clock root and each of a plurality of clock sinks of the digital circuit associated with the first clock root based on the timing analysis data; and
displaying the first clock root and each clock sink associated with the first clock root along an axis representing time delay, wherein each clock sink is positioned along the axis of the skew clock tree relative to the first clock root based on each clock sink's determined propagation time delay.

2. The method of claim 1 wherein displaying the first clock root and each clock sink associated with the first clock root enables the user to determine whether the skew clock tree is balanced.

3. The method of claim 1 wherein the skew clock tree includes a plurality of circuit components interconnected between the first clock root and one or more of the plurality of clock sinks associated with the first clock root, the method further comprising:
determining a propagation time delay between the first clock root and each of the plurality of circuit components based on the timing analysis; and
positioning each circuit component along the axis of the skew clock tree relative to the first clock root and the clock sinks associated with the first clock root based on each circuit component's determined propagation time delay.

4. The method of claim 3 wherein the circuit components include one or more of buffers, inverters, clock gates, clock multiplexers, and clock dividers.

5. The method of claim 3 wherein displaying the first clock root and each clock sink associated with the first clock root further comprises displaying one or more interconnections between the first clock root, the circuit components, and the clock sinks associated with the first clock root.

6. The method of claim 3 further comprising mapping colors to the circuit components in accordance with the type of each circuit component.

7. The method of claim 3 further comprising displaying a path of reconvergence visually represented by a dashed line in the displayed skew clock tree.

8. The method of claim 1 further comprising mapping colors to the plurality of clock sinks associated with the first clock root in accordance with their determined propagation time delay.

9. The method of claim 1 further comprising:
determining a propagation time delay between a second clock root of the digital circuit and each of a plurality of clock sinks associated with the second clock root based on the timing analysis data; and
displaying the second clock root and each of the plurality of clock sinks associated with the second clock root along the axis representing time delay, wherein each clock sink is positioned along the axis of the skew clock tree relative to the second clock root based on each clock sink's determined propagation time delay.

10. The method of claim 9 wherein the displayed skew clock tree comprises a first displayed clock tree comprising the first clock root and each clock sink associated with the first clock root and a second displayed clock tree comprising the second clock root and each clock sink associated with the second clock root; and
wherein displaying the second clock root and each clock sink associated with the second clock enables the user to determine whether the first displayed clock tree is balanced with respect to the second displayed clock tree.

11. The method of claim 9 wherein the displayed skew clock tree comprises a parent clock tree comprising the first clock root and each clock sink associated with the first clock tree and a child clock tree comprising the second clock root and each clock sink associated with the second clock root; and
wherein the method further comprises displaying a dashed lined to visually represent a relationship between the parent clock tree and the child clock tree.

12. A computer program product having a computer-readable medium for storing instructions to present a user with a display of a skew clock tree, the computer program product comprising:
code for receiving timing analysis data for a digital circuit;
code for determining a propagation time delay between a first clock root and each of a plurality of clock sinks of the digital circuit associated with the first clock root based on the timing analysis data; and
code for displaying the first clock root and each clock sinks associated with the first clock root along an axis representing time delay, wherein each clock sink is positioned along the axis of the skew clock tree relative to the first clock root based on each clock sink's determined propagation time delay.

13. The computer program product of claim 12 wherein the code for displaying the first clock root and each clock sink associated with the first clock root of the skew clock tree enables the user to determine whether the skew clock tree is balanced.

14. The computer program product of claim 12 wherein the skew clock tree includes a plurality of circuit components interconnected between the first clock root and one or more of the plurality of clock sinks associated with the first clock root, the computer program product further comprising:
code for determining a propagation time delay between the first clock root and each of the plurality of circuit components based on the timing analysis; and
code for positioning each circuit component along the axis relative to the first clock root and the clock sinks associated with the first clock root based on each circuit component's determined propagation time delay.

15. The computer program product of claim 14 wherein the circuit components include one or more of buffers, inverters, clock gates, clock multiplexers, and clock dividers.

16. The computer program product of claim 14 wherein the displayed skew clock tree shows interconnections between the first clock root, the circuit components, and the clock sinks associated with the first clock root.

17. The computer program product of claim 14 further comprising code for mapping colors to the circuit components in accordance with the type of each circuit component.

18. The computer program product of claim 12 further comprising code for mapping colors to the plurality of clock sinks associated with the first clock sink in accordance with their determined propagation time delay.

19. The computer program product of claim 12 further comprising code for displaying a path of reconvergence visually represented by a dashed line in the displayed skew clock tree.

20. The computer program product of claim 12 further comprising:
code for determining a propagation time delay between a second clock root of the digital circuit and each of a plurality of clock sinks associated with the second clock root based on the timing analysis data; and
code for displaying the second clock root and each of the plurality of clock sinks associated with the second clock root along the axis representing time delay, wherein each clock sink is positioned along the axis relative to the second clock root based on each clock sink's determined propagation time delay.

21. The computer program product of claim 20 wherein the displayed skew clock tree comprises a first displayed clock tree comprising the first clock root and each clock sink associated with the first clock root and a second displayed clock tree comprising the second clock root and each clock sink associated with the second clock root; and
wherein the code for displaying the first clock root and each clock sink associated with the first clock root and displaying the second clock root and each clock sink associated with the second clock enables the user to determine whether the first displayed clock tree is balanced with respect to the second displayed clock tree.

22. The computer program product of claim 20 wherein the displayed skew clock tree comprises a parent clock tree comprising the first clock root and each clock sink associated with the first clock tree and a child clock tree comprising the second clock root and each clock sink associated with the second clock root, the computer program product further comprising:
code for displaying a dashed lined to visually represent a relationship between the parent clock tree and the child clock tree.

23. The computer program product of claim 20 further comprising code for connecting one of the plurality of clock sinks associated with the first clock root to the second clock root.

24. A graphical user interface for a computer system display, comprising:
a first portion configured to display an axis representing time delay with units of time displayed on the axis; and
a second portion configured to display a first clock root and a plurality of clock sinks associated with the first clock root of a clock tree along the axis, each clock sink associated with the first clock root having a predetermined propagation time delay from the first clock root, wherein each clock sink associated with the first clock root is positioned along the axis relative to the first clock root based on each clock sink's propagation time delay.

25. The graphical user interface of claim 24 wherein the second portion is further configured to display the first clock root and each clock sink associated with the first clock root of the skew clock tree to enable a user to determine whether the skew clock tree is balanced.

26. The graphical user interface of claim 24 wherein the second portion is further configured to display a plurality of circuit components interconnected between the first clock root and one or more of the plurality of clock sinks associated with the first clock root, each circuit component having a predetermined propagation time delay from the first clock root, and wherein each circuit component is positioning along the axis relative to the first clock root and the clock sinks associated with the first clock root based on each circuit component's predetermined propagation time delay.

27. The graphical user interface of claim 26 wherein the second portion is further configured to display interconnections between the first clock root, the circuit components, and the clock sinks associated with the first clock root.

28. The graphical user interface of claim 24 wherein the second portion is further configured to display a second clock root and a plurality of clock sinks associated with the second clock root of the clock tree along the axis, each clock sink associated with the second clock root having a predetermined propagation time delay from the second clock root, wherein each clock sink associated with the second clock root is positioned along the axis relative to the second clock root based on each clock sink's propagation time delay.

29. The graphical user interface of claim 28 wherein the second portion is configured to display the first clock root and each clock sink associated with the first clock root and display the second clock root and each clock sink associated with the second clock to enable a user to determine whether the first displayed clock tree is balanced with respect to the second displayed clock tree.

30. The graphical user interface of claim 28 wherein the second portions is further configured to display a parent clock tree comprising the first clock root and each clock sink associated with the first clock tree and a child clock tree comprising the second clock root and each clock sink associated with the second clock root, and wherein the second portion is configured to display a dashed lined to visually represent a relationship between the parent clock tree and the child clock tree.
